(19) United States
(12) Patent Application Publication
(10) Pub. No.: US 2005/0140201 A1
(43) Pub. Date: Jun. 30, 2005

(54) Wheel cover for automobile

(76) Inventor: Wen-Chang Wang, Tainan Hsien (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/747,337

(22) Filed: Dec. 29, 2003

(51) Int. Cl. B60B 7/00

(52) U.S. Cl. 301/37.101; 301/37.108

(57) ABSTRACT

A wheel cover for an automobile wheel cover includes a main body having a plurality of light emitting members, and a generating device mounted in the main body and including a housing, a shaft, a rotor, a counterweight having a sensing body, a coil set, and a circuit board having a sensing body that is movable to align with the sensing body of the counterweight. Thus, the light emitting members of the wheel cover blinks intermittently during movement of the automobile to indicate patterns having a fixed shape, thereby enhancing the aesthetic quality of the wheel cover, and thereby providing a warning effect to other person on the road.

### BACKGROUND OF THE INVENTION

1. Field of the Invention

The present invention relates to a wheel cover, and more particularly to a wheel cover for an automobile.

2. Description of the Related Art

A conventional wheel cover for an automobile comprises a main body provided with a plurality of light emitting members, and a generating device mounted in the main body and electrically connected to the light emitting members of the main body. The generating device includes a rotor and a coil. Thus, when the automobile is moving, the wheel cover is also rotated, so that the main body and the generating device are rotated synchronously. At this time, the rotor is rotated relative to the coil to produce a magnetic effect therebetween, thereby producing an electric current which is directly transmitted to the light emitting members of the main body to provide a lighting effect.

However, the light emitting members light constantly to form a vague optical circle, thereby greatly decreasing the attractive effect and aesthetic quality of the wheel cover. In addition, the light emitting members are fixed on the main body of the wheel cover, so that the user needs to replace the whole wheel cover to change the arrangement of the light emitting members, thereby decreasing the versatility of the wheel cover.

### SUMMARY OF THE INVENTION

The primary objective of the present invention is to provide a wheel cover for an automobile, wherein the light emitting members of the wheel cover blinks intermittently during movement of the automobile to indicate patterns or characters having a fixed shape, thereby enhancing the aesthetic quality of the wheel cover, and thereby providing a warning effect to other person on the road.

Another objective of the present invention is to provide a wheel cover for an automobile, wherein the user can change and replace removable panels having different patterns to fit the practical requirement without having to replace the whole cover, thereby greatly enhancing the versatility of the whole cover.

In accordance with the present invention, there is provided a wheel cover, comprising:
a main body having a center formed with a receiving chamber and having a periphery provided with a plurality of light emitting members; and
a generating device mounted in the receiving chamber of the main body and including a housing mounted in the receiving chamber of the main body, a shaft rotatably mounted in the housing, a magnetic rotor secured on the shaft, a counterweight secured on the shaft and having a side provided with a sensing body, a coil set secured in the housing to rotate therewith and enclosed around the rotor, and a circuit board secured on a side of the coil set to rotate therewith and having a side provided with a sensing body that is movable to align with the sensing body of the counterweight.

Further benefits and advantages of the present invention will become apparent after a careful reading of the detailed description with appropriate reference to the accompanying drawings.

### BRIEF DESCRIPTION OF THE DRAWINGS

FIG. 1 is a side plan exploded cross-sectional view of a wheel cover for an automobile in accordance with the preferred embodiment of the present invention;

FIG. 2 is a partially cut-away side plan cross-sectional assembly view of the wheel cover in accordance with the preferred embodiment of the present invention;

FIG. 3 is a front plan assembly view of the wheel cover in accordance with the preferred embodiment of the present invention;

FIG. 4 is a front plan assembly view of a wheel cover for an automobile in accordance with another embodiment of the present invention; and

FIG. 5 is a partially cut-away plan cross-sectional view of the wheel cover taken along line 5-5 as shown in FIG. 4.

### DETAILED DESCRIPTION OF THE INVENTION

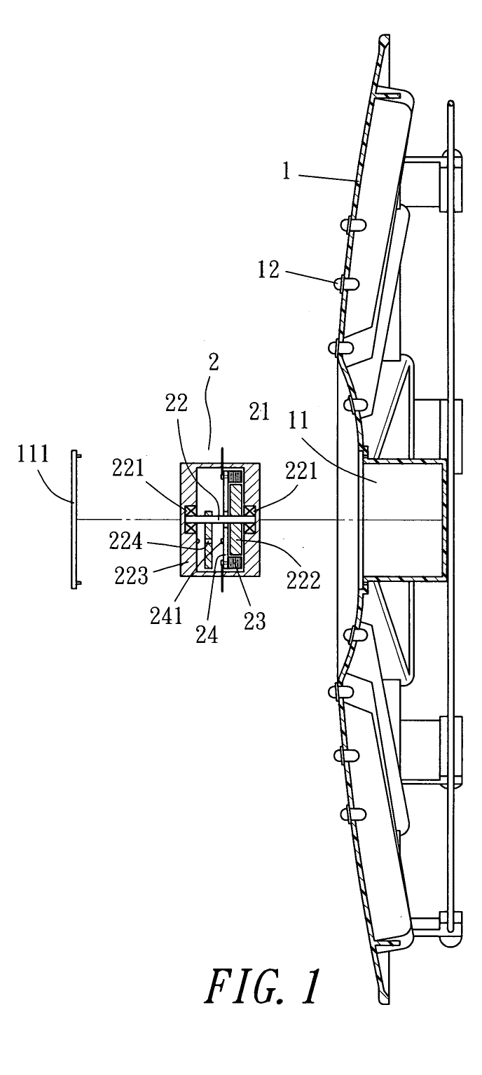

Referring to the drawings and initially to FIGS. 1-3, a wheel cover for an automobile in accordance with the preferred embodiment of the present invention comprises a main body 1, and a generating device 2.

The main body 1 has a center formed with a receiving chamber 11. An outer cover 111 is mounted in the receiving chamber 11 of the main body 1 to enclose the generating device 2 in the receiving chamber 11 of the main body 1.

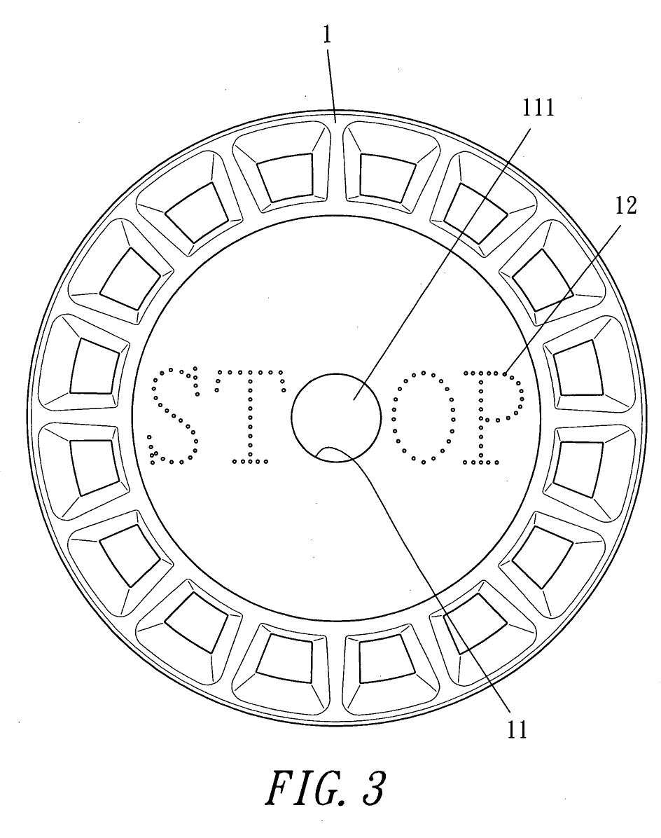

The main body 1 has a periphery provided with a plurality of light emitting members 12 arranged around the receiving chamber 11 of the main body 1. Preferably, each of the light emitting members 12 is a light emitting diode (LED). In addition, the light emitting members 12 are arranged to form special patterns or characters as shown in FIG. 3.

The generating device 2 is mounted in the receiving chamber 11 of the main body 1 and is electrically connected to the light emitting members 12 of the main body 1 to supply an electric power to the light emitting members 12 of the main body 1.

The generating device 2 includes a housing 21 mounted in the receiving chamber 11 of the main body 1, a shaft 22 rotatably mounted in the housing 21, a magnetic rotor 222 secured on the shaft 22, a counterweight 223 secured on the shaft 22 and having a side provided with a sensing body 224, a coil set 23 secured in the housing 21 to rotate therewith and enclosed around the rotor 222, and a circuit board 24 secured on a side of the coil set 23 to rotate therewith and having a side provided with a sensing body 241 that is movable to align with the sensing body 224 of the counterweight 223. The shaft 22 is co-axial with the main body 1 and has two ends each provided with a bearing 221 rotatably mounted in the housing 21. The circuit board 24 is electrically connected to the light emitting members 12 of the main body 11.

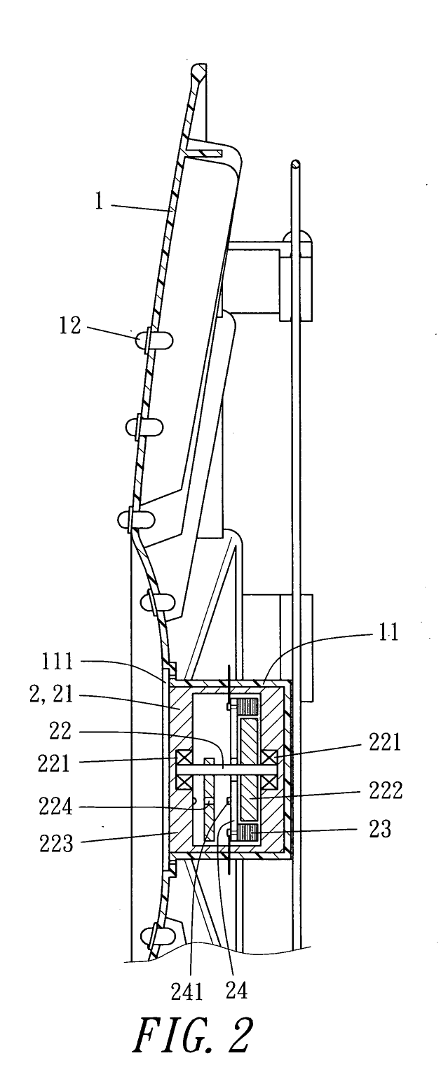

In operation, when the automobile is moving, the wheel cover is also rotated, so that the main body 1 and the generating device 2 are rotated synchronously. At this time, the shaft 22 of the generating device 2 is fixed without rotation by the weight of the counterweight 223. Thus, the coil set 23 is rotated relative to the rotor 222 successively to produce a magnetic effect therebetween, thereby producing an electric current. When the generating device 2 and the circuit board 24 are rotated to the position as shown in FIG. 2, the sensing body 241 of the circuit board 24 is rotated to align with the sensing body 224 of the counterweight 223, so that the rotated sensing body 241 of the circuit board 24 is mutually induced with the fixed sensing body 224 of the counterweight 223, thereby forming an electrical connection, such that the electric current produced when the coil set 23 is rotated relative to the rotor 222 is transmitted to the light emitting members 12 of the main body 1, thereby providing a lighting effect as shown in FIG. 3.

On the contrary, when the generating device 2 is rotated to a position where the sensing body 241 of the circuit board 24 does not align with the sensing body 224 of the counterweight 223, the electrical connection of the circuit board 24 is shut, thereby interrupting the electric power transmitted to the light emitting members 12 of the main body 1, such that the light emitting members 12 of the main body 1 stop lighting.

Accordingly, the rotated sensing body 241 of the circuit board 24 is mutually induced with the fixed sensing body 224 of the counterweight 223 in an intermittent manner, such that the electric current produced when the coil set 23 is rotated relative to the rotor 222 forms connection and disconnection in an intermittent manner, so that the light emitting members 12 of the main body 1 light and distinguish in an intermittent manner, thereby producing a blinking effect. In addition, the light emitting members 12 of the main body 1 blinks intermittently during movement of the automobile to indicate patterns or characters having a fixed shape, thereby enhancing the aesthetic quality of the wheel cover, and thereby providing a warning effect to other person on the road.

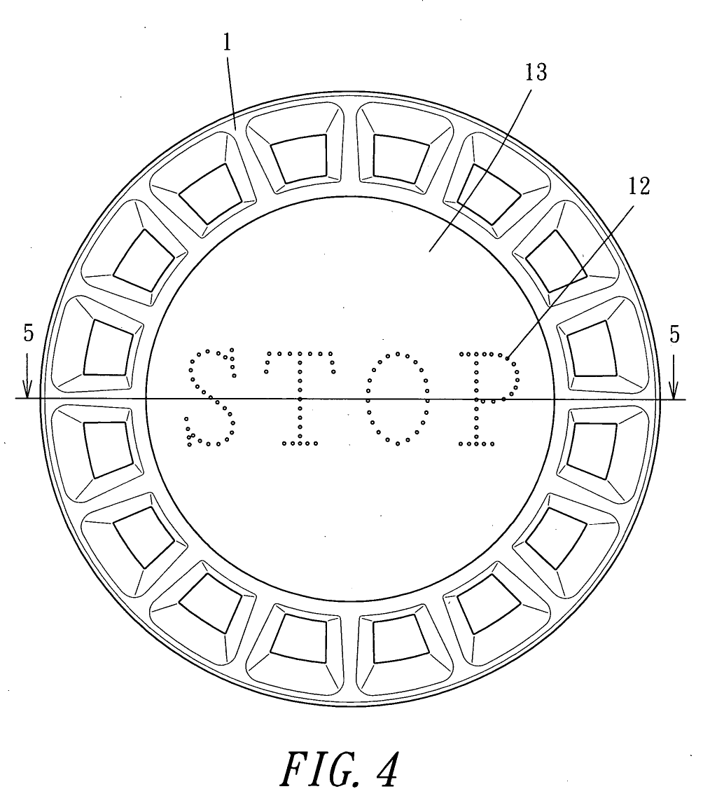

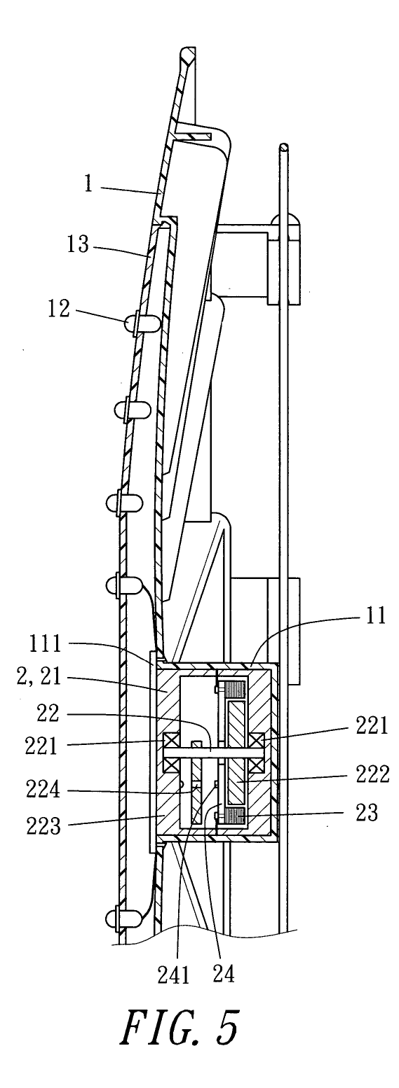

Referring to FIGS. 4 and 5, in accordance with another embodiment of the present invention, the wheel cover further comprises a removable panel 13 detachably mounted on the main body 1, and the light emitting members 12 are mounted on the removable panel 13. Thus, the user can change and replace removable panels 13 having different patterns to fit the practical requirement without having to replace the whole cover, thereby enhancing the versatility of the whole cover.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A wheel cover, comprising:
a main body having a center formed with a receiving chamber and having a periphery provided with a plurality of light emitting members; and
a generating device mounted in the receiving chamber of the main body and including a housing mounted in the receiving chamber of the main body, a shaft rotatably mounted in the housing, a magnetic rotor secured on the shaft, a counterweight secured on the shaft and having a side provided with a sensing body, a coil set secured in the housing to rotate therewith and enclosed around the rotor, and a circuit board secured on a side of the coil set to rotate therewith and having a side provided with a sensing body that is movable to align with the sensing body of the counterweight.

2. The wheel cover in accordance with claim 1, wherein when the wheel cover is rotated, the main body and the generating device are rotated synchronously, and the shaft of the generating device is fixed without rotation by a weight of the counterweight, so that the coil set is rotated relative to the rotor.

3. The wheel cover in accordance with claim 2, wherein when the sensing body of the circuit board is rotated to align with the sensing body of the counterweight, the rotated sensing body of the circuit board is induced with the fixed sensing body of the counterweight, thereby forming an electrical connection, such that an electric current produced when the coil set is rotated relative to the rotor is transmitted to the light emitting members of the main body.

4. The wheel cover in accordance with claim 3, wherein the rotated sensing body of the circuit board is induced with the fixed sensing body of the counterweight in an intermittent manner, so that the electric current produced when the coil set is rotated relative to the rotor forms connection and disconnection in an intermittent manner, and the light emitting members of the main body light and distinguish in an intermittent manner.

5. The wheel cover in accordance with claim 2, wherein the light emitting members of the main body blinks during movement of the wheel cover to indicate patterns having a fixed shape.

6. The wheel cover in accordance with claim 1, further comprising an outer cover mounted in the receiving chamber of the main body to enclose the generating device in the receiving chamber of the main body.

7. The wheel cover in accordance with claim 1, wherein the light emitting members are arranged around the receiving chamber of the main body.

8. The wheel cover in accordance with claim 1, wherein the light emitting members are arranged to form patterns.

9. The wheel cover in accordance with claim 1, wherein the light emitting members are arranged to form characters.

10. The wheel cover in accordance with claim 1, wherein the shaft is co-axial with the main body and has two ends each provided with a bearing rotatably mounted in the housing.

11. The wheel cover in accordance with claim 1, wherein the circuit board is electrically connected to the light emitting members of the main body.

12. The wheel cover in accordance with claim 1, further comprising a removable panel detachably mounted on the main body, and the light emitting members are mounted on the removable panel.
